(19) United States
(12) Patent Application Publication
(10) Pub. No.: US 2006/0002774 A1
(43) Pub. Date: Jan. 5, 2006

(54) Apparatus for dispensing particulate material into a pneumatic conveying line

(76) Inventors: Alvin J. Stumborg, Humboldt (CA); Harry Isaac, Saltcoats (CA)

Correspondence Address: Ryan W. Dupuis;Ade & Company, 1700-360 Main Street, Winnipeg, MB, R3C 3Z3, CA

(21) Appl. No.: 11/166,136

(22) Filed: Jun. 27, 2005

Related U.S. Application Data
(63) Continuation-in-part of application No. PCT/CA03/02026, filed on Dec. 23, 2003.
(60) Provisional application No. 60/436,014, filed on Dec. 26, 2002.

(51) Int. Cl. B65G 53/08

(52) U.S. Cl. 406/57

(57) ABSTRACT

An apparatus is used for dispensing particulate material into a pneumatic conveying line which includes an air passage for connection in series with the pneumatic conveying line. A flow restrictor in the air passage, for example a venturi, produces a drop in air pressure in the pneumatic conveying line. An auger feeds the particulate material adjacent the outlet side of the flow restrictor whereby particulate material in a feed tube surrounding the auger is drawn into the pneumatic conveying line. A branched line connects the pneumatic conveying line to an inlet of the feed tube. Shutoff valves in the conveying line and the branched line permit airflow to be directed through either the conveying line or the branched line. The feed tube can be pneumatically purged by opening the shutoff valve in the branched line.

This application is a continuation-in-part of International (PCT) Patent Application Serial No. PCT/CA03/02026, filed Dec. 23, 2003 and claims priority under 35 U.S.C. 119 from U.S. Provisional Application Ser. No. 60/436,014, filed Dec. 26, 2002.

### FIELD OF THE INVENTION

This invention relates to an apparatus for dispensing particulate material into a pneumatic conveying line and more particularly relates to an apparatus of this type which is arranged to be mounted integrally on a source of particulate material for dispensing particulate material from the source into the pneumatic conveying line.

### BACKGROUND

The use of pneumatic conveying lines is known in various industries for displacing particulate material from one location to another. Depending upon the industry, the type of particulate material may include grain, feed, fertilizer, sand, salt and plastics as well as many others. When using a pneumatic conveying line it is desirable to provide an apparatus for dispensing the particulate material from a source into the pneumatic conveying line in an efficient and controllable manner.

Examples of devices for dispensing particulate material into a pneumatic conveying line are found in U.S. Pat. No. 3,712,681 to Marino, U.S. Pat. No. 4,279,556 to Ronning, U.S. Pat. No. 3,588,180 to Herr, U.S. Pat. No. 4,109,966 to Boyhont, U.S. Pat. No. 5,087,155 to Herman and U.S. Pat. No. 5,125,771 also to Herman. In each of these devices a generally horizontal auger is provided for urging particulate material from a source to an outlet chamber connected to the conveying line. In order to prevent blow back of air pressure from the pneumatic conveying line back through the auger, a flap valve at the outlet of the auger is generally required to ensure that a plug of particulate material builds up at the outlet of the auger to prevent the passage of air therethrough.

Forcing the plug of particulate material through the auger tube and the complex path past the flap valve at the outlet of the auger requires considerable driving force to operate the auger. This arrangement also traps particulate material within the outlet of the auger as the source of particulate material is depleted, making it difficult to clean out all of the particulate material from the device during a typical unloading operation.

When handling medicated feeds for instance, as in the agricultural industry, total clean out is required to prevent contamination of feed product to be later dispensed through the apparatus. Total clean out is also required when handling GMO (Genetically Modified Organisms) as certain individuals request that GMO's be not mixed with their usual product. Other applications requiring total clean out include the handling of organic grains as well as the handling of seed in round seed cleaning plants to prevent contamination from one product to another due to left over product in the handling equipment used.

### SUMMARY

According to one aspect of the present invention there is provided an apparatus for dispensing a particulate material from a source of particulate material into a pneumatic conveying line, the apparatus comprising:

an air passage having an air inlet and an air outlet arranged for connection in series with the pneumatic conveying line;

a flow restrictor mounted in the air passage arranged to produce a drop in air pressure in the pneumatic conveying line from an inlet side in communication with the air inlet of the air passage to an outlet side in communication with the air outlet of the air passage;

a feed tube having a feed inlet arranged to be connected to the source of particulate material and a feed outlet connected to the air passage adjacent the outlet side of the flow restrictor; and

a feed mechanism arranged to displace particulate material through the feed tube from the source at the feed inlet of the feed tube to the outlet side of the flow restrictor in the air passage at the feed outlet of the feed tube.

The particular arrangement of a feed tube having a feed outlet adjacent the outlet side of the flow restrictor in the conveying line as noted above creates a pressure drop adjacent the outlet of the feed tube which draws remaining particulate material in the feed tube into the pneumatic conveying line once the source of particulate material has been depleted. Accordingly, the flow restrictor provides a sufficient vacuum at the outlet of the feed tube to ensure complete clean out of the apparatus once a source of particulate material has been depleted and dispensed into a pneumatic conveying line.

The flow restrictor may comprise an enclosed passage having a cross sectional area which is less than the air inlet, the enclosed passage extending in a longitudinal direction of the air passage partway across the feed outlet of the feed tube.

The flow restrictor preferably comprises a venturi. Other flow restrictors to produce a pressure drop in the air passage, including orifice plates, baffles and the like, may be used effectively in further embodiments. For example, the flow restrictor may comprise a restricting member being arranged to define at least one restricted orifice between the air inlet and the air outlet of the air passage.

There may be provided an air chamber at a point of communication of the air passage with the feed tube, the air passage communicating with the air chamber adjacent a bottom side of the air chamber. The feed tube preferably communicates with the air chamber above the air passage.

When flow directions through the air inlet and the air outlet respectively generally lie in a common plane, the feed tube preferably extends perpendicularly to the common plane of the flow directions. The air inlet and the air outlet preferably each extend tangentially to the feed tube.

The air passage may comprise an air tube which is arranged to be selectively connected in series with the pneumatic conveying line.

The air tube preferably includes connection means for releasably connecting the air tube to the pneumatic conveying line air tube using quick couplers or rim flanges with threaded fasteners.

The feed mechanism may comprise an auger, preferably including flighting which substantially spans a full diameter of the feed tube.

When the feed mechanism comprises an auger rotatable within the feed tube, auger movement at a periphery of the feed tube directly adjacent to the flow restrictor is preferably in a same direction as flow through the flow restrictor.

When the source of particulate material has a hopper for dispensing the particulate material therefrom, the feed tube may be mounted integrally on the hopper of the source of particulate material.

Alternatively, when the apparatus is portable, the feed mechanism may include an inlet hopper for receiving the particulate material.

The apparatus may be provided in combination with a particulate material handling trailer, a truck box, a railcar or a storage bin and the like having a hopper for dispensing the particulate material therefrom. The feed tube in this instance is arranged to be mounted integrally on the hopper.

Mounting the feed tube integrally with a hopper of the source of particulate material in a sealed manner can also be employed so that precautions to prevent blow back are not required. Orienting the auger of the feed tube in an upright orientation is useful to assist in cleaning out the apparatus at the end of an unloading operation and permits the particulate material to accumulate within the feed tube so that no flap valve is required to form a plug of material in the feed tube, thus lowering the power requirements to drive the apparatus.

Alignment of the feed outlet with the air chamber permits the material in the feed tube to be fed directly into the air stream of the pneumatic conveying line which also reduces power requirements as the material is not forced through a bend in the feed tube or past any obstacles at a location where the feed tube couples to the pneumatic conveying line.

According to a further aspect of the present invention there is provided an apparatus for dispensing a particulate material from a source of particulate material into a pneumatic conveying line, the apparatus comprising:

an air passage having an air inlet and an air outlet arranged for connection in series with the pneumatic conveying line;

a flow restrictor mounted in the air passage arranged to produce a drop in air pressure in the pneumatic conveying line from an inlet side in communication with the air inlet of the air passage to an outlet side in communication with the air outlet of the air passage;

a feed tube having a feed inlet arranged to be connected to the source of particulate material and a feed outlet connected to the air passage adjacent the outlet side of the flow restrictor;

a feed mechanism arranged to displace particulate material through the feed tube from the source at the feed inlet of the feed tube to the outlet side of the flow restrictor in the air passage at the feed outlet of the feed tube; and

a branched line having an inlet for connection to the pneumatic conveying line upstream from the air passage and an outlet for connection upstream from the feed tube and a first shutoff valve in series with the branched line for selectively interrupting communication of the pneumatic conveying line with the feed inlet.

Preferably there is also provided a second shutoff valve for connection in series with pneumatic conveying line upstream from the flow restrictor. The apparatus is thus operable in a first operating condition in which the first shutoff valve is closed and the second shutoff valve is open whereby airflow through the pneumatic conveying line is fully diverted through the flow restrictor. Also, the apparatus is operable in a second operating condition in which the first shutoff valve is open and the second shutoff valve is closed whereby airflow through the pneumatic conveying line is fully diverted through the feed tube.

The outlet of the branched line is preferably coupled to the feed inlet.

### BRIEF DESCRIPTION OF THE DRAWINGS

In the accompanying drawings, which illustrate exemplary embodiments of the present invention:

FIG. 1 is a side elevational view of a particulate material handling trailer upon which the apparatus for dispensing particulate material into a pneumatic conveying line is mounted.

FIG. 2 is a sectional view of the apparatus along the line 2-2 of FIG. 1.

FIG. 3 is an end view of the air chamber of the apparatus of FIG. 1 as viewed from the air inlet end thereof.

FIG. 4 is a top view of the air chamber at the feed outlet of the feed tube with the feed tube shown removed therefrom.

FIG. 5 is an isometric view of the flow restrictor components mounted within the air chamber of the apparatus.

FIG. 6 is a front elevational view of an alternative embodiment of the apparatus in which the feed tube is mounted integrally within a hopper of a source of particulate material.

FIG. 7 is a sectional view of a further embodiment of the apparatus.

FIG. 8 is a perspective view of a further embodiment of the flow restrictor components to be mounted within the air chamber of the apparatus.

FIG. 9 is a side elevational view of a further particulate material handling trailer upon which a further embodiment of the apparatus is mounted for dispensing particulate material into a pneumatic conveying line.

FIG. 10 is a partly sectional end elevational view of the apparatus according to FIG. 9.

FIG. 11 is an end elevational view of the apparatus according to FIGS. 9 and 10.

FIG. 12 is a schematic illustration of the apparatus according to FIG. 9 in connection with a source of air under pressure.

### DETAILED DESCRIPTION

Identical reference numerals, used in the Figures of the various embodiments, refer to like parts.

Referring to the accompanying drawings, there is illustrated an apparatus generally indicated by reference numeral 10. The apparatus 10 is intended for use in dispensing particulate material from a source of particulate material into a pneumatic conveying line 12 of the type commonly known for conveying particulate material. The apparatus 10 is arranged to be mounted on the hopper 14 of the source, integrally or selectively separable therefrom, for readily dispensing the particulate material from the source.

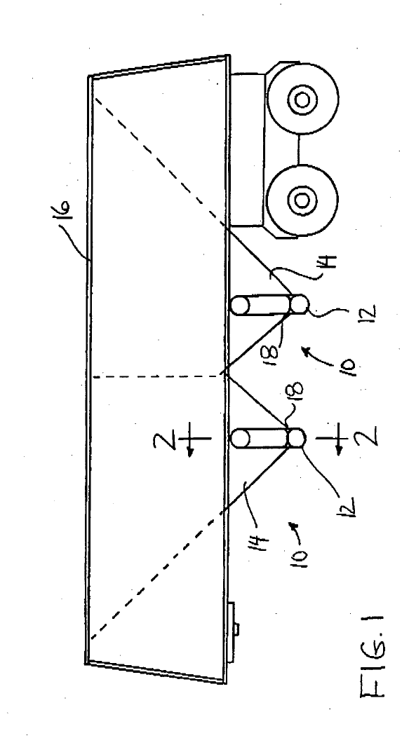

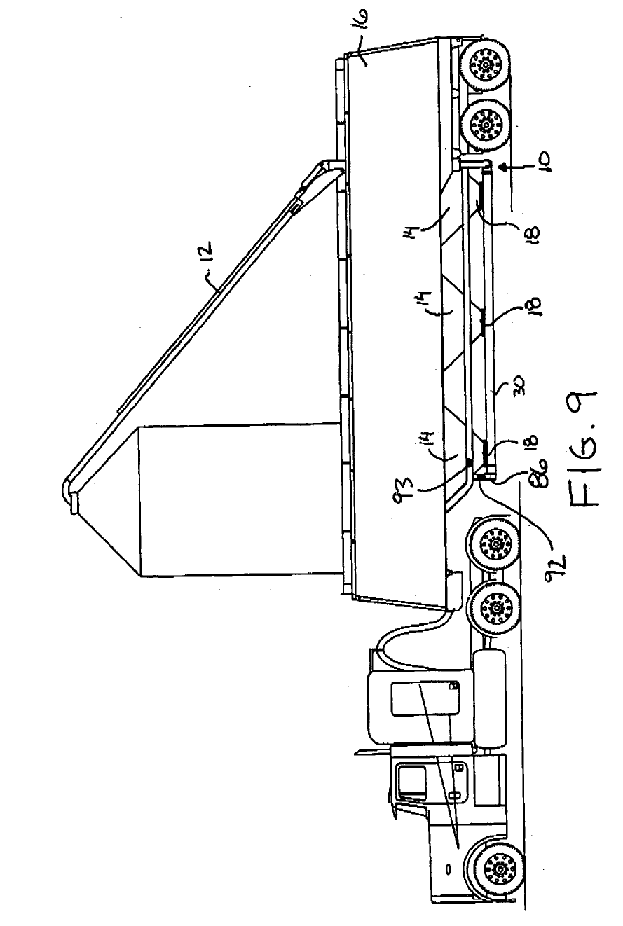

As illustrated in FIGS. 1 and 9, the source comprises a particulate material handling trailer 16 having sufficient ground clearance below the hoppers that the hoppers 14 meet at an apex 18 with the apparatus 10 being mounted thereunder. In further arrangements the apparatus 10 may be mounted on any particulate material storage device such as a bin, a truck box or a rail car provided that a hopper be mounted thereon upon which the apparatus 10 may be integrally secured.

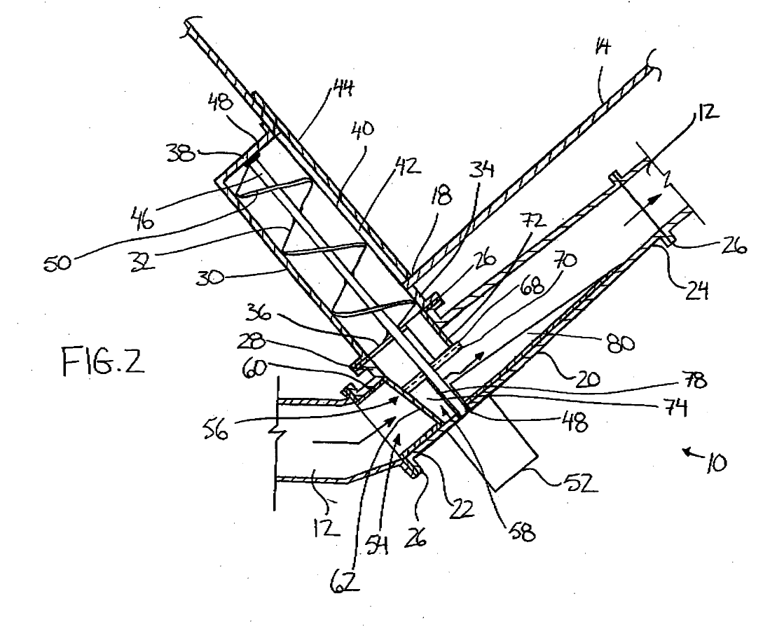

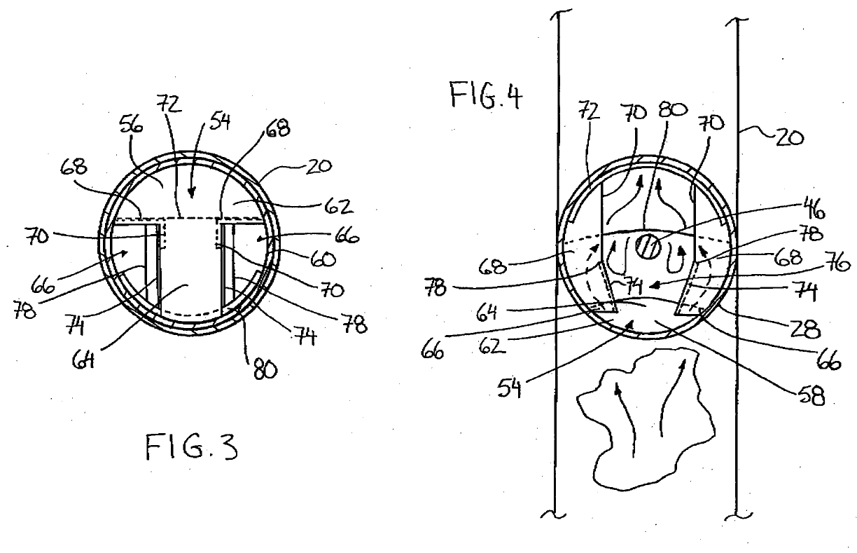

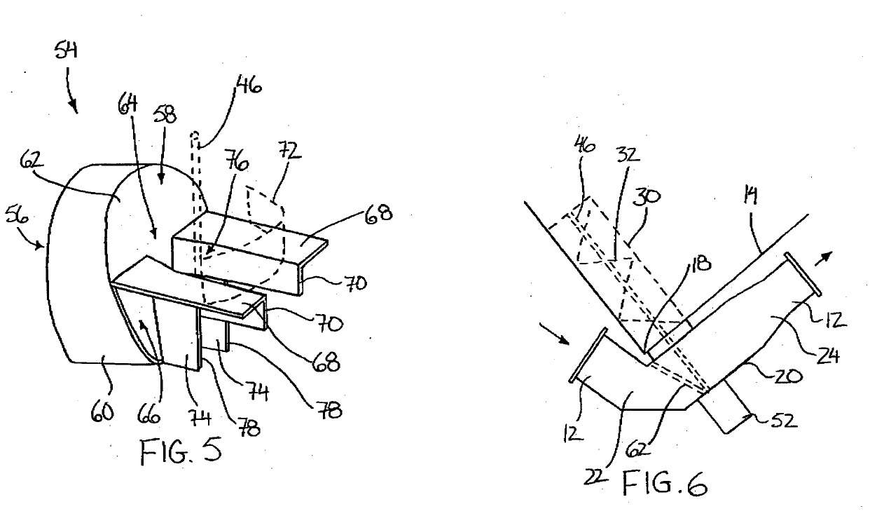

Referring initially to FIGS. 1 through 5 a first embodiment of the apparatus 10 is illustrated. An air tube 20 is provided which extends in a longitudinal direction from an air inlet 22 at one end thereof to an air outlet 24 at an opposite end thereof. The air tube 20 has side walls which are slightly tapered such that an overall diameter of the air tube is reduced from the inlet to the outlet thereof. Each of the inlet and outlet 22 and 24 includes a rim flange 26 mounted thereon which extends radially outwardly from a periphery of the tube for sealing engagement with the pneumatic conveying line 12. The rim flanges 26 permit sealing gaskets to be mounted between the air tube and the pneumatic conveying line 12 within which the air tube 20 is connected in series. The air tube defines an air passage through which an air flow of the pneumatic conveying line passes through in operation.

A feed coupling 28 is provided on one side of the air tube between the inlet and outlet thereof for introducing particulate material therethrough into the conveying line 12. The feed coupling 28 generally comprises a collar mounted in the wall of the air tube 20 such that an axis of the collar extends radially outwardly from a longitudinal axis of the air tube 20. The feed coupling 28 similarly includes a rim flange 26 thereon for connection to a feed tube 30.

The feed tube 30 is an elongate tube arranged for housing an auger 32 therein for feeding particulate material from the hopper 14 to the conveying line 12. The feed tube includes a collar 34 formed at a feed outlet 36 of the feed tube which includes a rim flange 26 mounted thereon for securement to the rim flange of the feed coupling 28. The feed tube 30 is enclosed at a capped end 38 opposite the feed outlet.

The feed tube 30 includes a feed inlet 40 in the form of an opening extending along one side of the tube in communication with an opening 42 in a side wall of the hopper 14. The feed tube 30 is secured to one of the side walls of the hopper 14 with a longitudinal axis of the tube lying parallel to the side wall of the hopper such that the feed tube extends at an upward incline from the feed outlet 36 to the capped end 38 at an angle of approximately 45 degrees with the hopper wall. Any other suitable hopper wall angle would also be appropriate.

The feed inlet 40 extends the length of the feed tube 30 along side the hopper 40 in alignment with the opening 42 in the hopper. The opening 42 in the hopper extends from the capped end 38 of the feed tube to the apex 18 of the hopper and includes a cover member 44 which is arranged to be selectively closed over the opening 42. The cover member 44 is preferably a panel which is slidably mounted within the hopper 14 for permitting selective communication between the hopper and the feed inlet 40. When closed the feed inlet 40 of the feed tube is also sealed shut.

The auger 32 includes a shaft 46 which is rotatably mounted within the feed tube 30 in alignment with a longitudinal axis of the feed tube. The longitudinal axis of the air tube 20 and the feed tube 30 are perpendicular to one another and arranged to lie in a substantially common plane such that the shaft 46 which extends along the longitudinal axis of the feed tube 30 extends radially outwardly from the air tube 20. Suitable bearings 48 support the ends of the shaft 46 at the capped end 38 of the feed tube and in the wall of the air tube 20 opposite the feed coupling 28 such that the shaft 46 extends diametrically across the air tube 20.

The flight 50 of the auger extends from the shaft 46 the full length of the feed tube 30 from the capped end 38 to the feed outlet 36 adjacent the feed coupling 28 of the air tube. A motor 52 is provided for driving rotation of the shaft 46 of the auger and is mounted externally on the air tube 20 opposite the feed coupling 28 for connection to the shaft 46 which extends through the side wall of the air tube.

A flow restrictor 54 is mounted within the air tube 20 between the air inlet and the air outlet thereof. The flow restrictor 54 is arranged to produce a pressure drop from an inlet side 56 in communication with the air inlet to an outlet side 58 in communication with the air outlet. The flow restrictor 54 is positioned within the air tube between the air inlet and the feed coupling 28 such that the outlet side 58 is located adjacent the feed coupling with the feed outlet of the feed tube 30 being positioned immediately downstream of the outlet side of the restrictor.

The flow restrictor 54 includes a collar 60 which snugly fits within an interior diameter of the air tube 20 and extends in the longitudinal direction of the tube from the air inlet 20 to the feed coupling 28. The collar 60 includes a rim flange 26 for connection with the rim flange at the air inlet of the air tube 20 and the conveying line 12.

A restricting plate member 62 spans across one end of the collar 60 spaced from the air inlet at the feed coupling 28. The plate member 62 extends at an incline from an inner end located at an inlet side of the feed coupling 28 to an outer end adjacent a side wall of the air tube 20 opposite the feed coupling 28 at a longitudinal position within the air tube 20 which is nearer to the air outlet 24 then the inner end of the plate member 62. The plate member is arranged to span between the walls of the air tube transversely to the longitudinal direction of both the air tube 20 and the feed tube 30.

A central restricting portion 64 of the plate member 62 spans the full height of the air tube 20 in alignment with the shaft 46 of the auger. A pair of restricted orifices 66 are defined in each side of the restricting plate member 62 on opposing sides of the central portion 64. The restricted orifices 66 extend only part way up from an outer side of the air tube opposite the feed coupling 28 such that a top portion of the air tube 20 adjacent the feed coupling 28 is fully enclosed by the restricting plate member 62. Each of the orifices 66 is thus defined between a respective side wall of the air tube 20 and a respective side edge of the central portion 64 of the restricting plate member, also being bound on an upper edge by the top portion of the restricting plate members 62.

A pair of feed restrictors 68 are mounted in the air tube 20 spaced outwardly towards the feed coupling 28 from the restricted orifices 66 for restricting feed of particulate material from the feed tube into the air tube. Each feed restrictor 68 comprises a plate member which extends transversely to a longitudinal direction of the feed tube generally parallel to the axis of the air tube 20. The two plates are located on opposing sides of the auger shaft 46 and define a space therebetween for receiving the auger shaft 46 and particulate material therethrough. Each feed restrictor 68 extends from the plate member 62 in the longitudinal direction of the air tube above a respective one of the restricted orifices 66 and includes a depending side flange 70 which extends downwardly from an inner side edge parallel to the plane of the tube axis and spaced apart from one another.

The feed outlet of the feed tube 30 is arranged to extend partway into the air tube 20 up to the feed restrictors 68 being bound at respective sides by the feed coupling 28 and the side walls of the air tube 20 and being bound at the inlet side by the restricting plate 62. The feed outlet 36 extending into the air tube is bound at the outlet side by an extension plate 72 extending from the feed tube 30 to the feed restrictors 68 partway into the air tube 20. The extension plate 72 is semi-circular in shape and is arranged to be continuous with the collar 34 formed in the feed tube 30. The extension plate 72 is supported by a respective rim flange 26 mounted between the feet coupling 28 and the feed tube 30. Particulate material which is urged from the source to the conveying line 12 by the auger 32 is directed into the feed outlet 36 which extends partway into the air tube and is then restricted by the feed restrictors 68 which deposit the particulate material centrally within the air tube 20 between the feed restrictor 68.

Beneath each of the feed restrictors 68 an enclosed passage is defined which directs the flow of air through the conveying line along respective sides of the air tube at the flow restrictor so that the air passes around both sides of the particulate material dispensed centrally within the air tube by the feed tube. Each enclosed passage is bound by a respective feed restrictor 68, side walls of the air tube 20 and a respective deflector plate 74. Each deflector side plate 74 is mounted at an inner end along a respective side edge of the central portion of the restricting plate member 62 to extend at an incline outwardly from one another towards a respective side wall of the air tube 20 generally in the longitudinal direction of the air tube. The deflector plates 74 are spaced apart on opposing sides of the shaft 46 of the auger for defining a suction zone 76 in the form of an air chamber or air passage therebetween.

The cross sectional area of each restricted orifice 66 is substantially less than the air inlet 22 and defines the area at an inlet end of each respective enclosed passage. The enclosed passages extend in the longitudinal direction of the air tube and are reduced in cross sectional area from the inlet side to the outlet side of the flow restrictor. The passages terminate at the respective free ends 78 of the deflector plates 74 at a longitudinal position which is substantially in alignment with the shaft 46 of the auger. In this arrangement two flow restricting passages are defined on opposing sides of a centrally obstructed zone between the feed restrictors 68 where particulate material is deposited.

A wear plate 80 is mounted within the air tube 20 and is arranged to line an inner wall of the air tube opposite the feed coupling 28. The wear plate 80 is generally semicircular in shape and extends in the longitudinal direction of the air tube downstream from the feed coupling 28. The wear plate 80 is selectively separable from the air tube 20 for replacement as required.

The apparatus 10 can be mounted integrally on a hopper 14 as illustrated in sealed engagement therewith such that the only opening in the hopper is exposed to the suction zone 76 of the apparatus to fully clean out the hopper in operation. In further arrangements the apparatus 10 may be constructed as a retrofit component for attachment to existing hoppers.

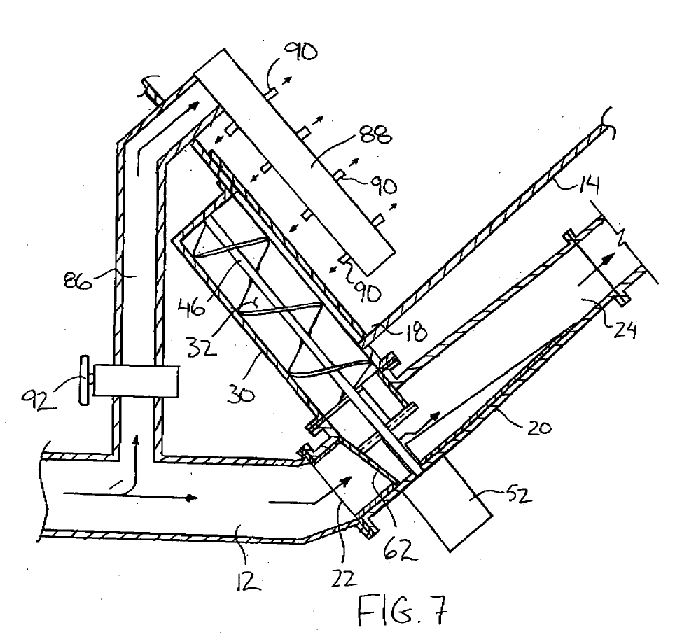

As shown in FIG. 6, in a further embodiment, the auger 32 and feed tube 30 within which it is mounted may be mounted integrally inside a hopper for increased clearance below the hopper. In this arrangement the auger would similarly be arranged to communicate with an apex of the hopper with a sleeve type cover being provided to selectively enclose the auger when not in use. Suitable applications for the apparatus 10 includes integral mounting on trailers 16 as illustrated as well as rail cars, truck boxes and storage bins for particulate material and the like.

In order to empty a source of particulate material having a hopper 14 and the apparatus 10 integrally mounted thereon, the apparatus is first connected in series with a pneumatic conveying line 12. The blower of the conveying line is then started to produce a flow of pressurized air through the air tube 20. The flow restrictor ensures that air pressure builds up at an inlet side thereof while the flow is accelerated through to the outlet side thereof. As shown in FIG. 4 the flow of air passes through the enclosed passages leading from the restricted orifices of the restricting plate member 62, wrapping around the deflector plates 74 and creating the suction zone 76 before continuing downstream from the flow restrictor 54. The void defined between the deflector plates 74 adjacent the restricting plate members 62 forms the suction zone around the auger shaft as the flow of air accelerates past the auger shaft along either side thereof.

In order to begin dispensing the particulate material into the conveying line, the cover within the hopper 14 is opened and rotation of the auger is actuated by the motor 52 to urge the particulate material from the feed inlet to the feed outlet of the feed tube 30. The upright orientation of the feed tube and the arrangement of the feed outlet 36 extending partway into the air tube up to the feed restrictors 68 ensures that the particulate material is packed within the feed tube and fills the full cross-sectional area of the feed tube at the feed outlet 36 thereof to prevent blow back. Blow back however is not a concern when the feed tube 30 is mounted integrally within a hopper 14 as the material would only be blown back into the enclosed source of particulate material anyway. The only opening in the hopper is sealed with respect to the feed inlet of the apparatus and thus the particulate material is prevented from being blown back into the surrounding environment. Continued operation of the auger continues to dispense the particulate material from the source into the suction zone 76 so that air passing along respective sides of the suction zone, as defined by the enclosed passages extending from the restricted orifices 66 of the plate member 62, collects the particulate material from the suction zone until the source is empty.

Because the auger is located at the apex of the hopper, the hopper is ensured of being fully emptied during an unloading operation. The upward inclination of the feed tube 30 ensures that the feed tube is emptied during an unloading operation by the assistance of gravity and the particular arrangement of the suction zone as a result of the restricted orifices 66 of the flow restrictor 54 as well as the simple construction having no bends in the feed path of particulate material from the feed tube to the air tube ensures that the apparatus 10 can be fully emptied during an unloading operation. The complete clean out of a hopper and the apparatus can thus be readily achieved for use of the apparatus with different particulate materials in succession of one another without contamination of one material to another.

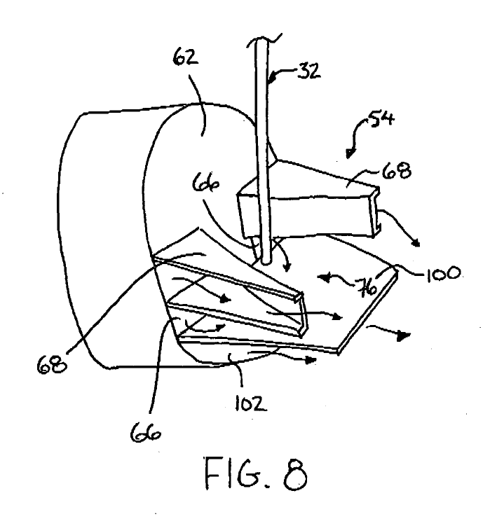

Turning now to the embodiment of FIG. 7, the apparatus 10 is further arranged for mixing or agitating particulate material in a hopper to which the apparatus is connected. The apparatus 10 includes a branched line 86 which is connected to the pneumatic conveying line 12 upstream from the air tube 20 to divert a portion of the pressurized supply air directly into the hopper. The branched line 86 has a cross sectional area which is smaller than that of the conveying line 12, for example it has a diameter of approximately 2 inches as compared to the conveying line 12 which may have a diameter in the order of 4 inches. The branched line 86 couples the pneumatic conveying line 12 to communicate with an agitator 88 supported within the hopper 14 adjacent the bottom end thereof.

The agitator 88 generally comprises a capped tube having a plurality of nozzles 90 mounted thereon for dispensing the pressurized supply therethrough into the hopper. The nozzles 90 are supported on the tube of the agitator at various angles and may be oriented to direct a flow of pressurized air at the corners of the hopper to assist in fully cleaning out the hopper when unloading. Some of the nozzles 90 may be directed upwards towards the top of the hopper primarily for mixing and agitating the particulate material while other nozzles 90 may be directed downward into the feed tube to assist in feeding particulate material into the auger 32.

By dispensing air under pressure through the nozzles 90 of the agitator, particulate material within the hopper is prevented from becoming compacted and settled which may otherwise cause difficulties when unloading the hopper. Supplying air under pressure from the pneumatic conveying line to the agitator within the hopper causes pressure to be balanced on either side of the auger within the feed tube 30 to prevent blowback through the auger back into the hopper. The agitation of the air under pressure enables particulate material to be fully cleaned out of even a low profile hopper having walls which are substantially less than 45° from horizontal.

The branched line 86 includes a shutoff valve 92 coupled in series therewith for controlling the flow rate of air being dispensed through the nozzles of the agitator. Less air is preferable for unloading finer particulate materials, for example powders. In general however, the shutoff valve 92 remains open as the pressure drop created by the restricting plate member 62 ensures that air normally flows from the hopper to the low pressure suction zone immediately downstream of the plate member 62.

The apparatus 10 according to the embodiment of FIG. 7 may further be used as a mixer for mixing particulate materials within a hopper. Providing a shutoff valve at the outlet of the air tube ensures that all of the air from the pneumatic conveying line 12 can be directed into the hopper. For increased mixing and agitation, the nozzles 90 of the agitator may be arranged to rotate or may be operated by a manifold to control which nozzles air is directed to. Directing air through an agitator positioned within a hopper has been discovered to stir particulate material by passing air therethrough up to a depth in the order of 5 feet when supported in a hopper. The apparatus according to FIG. 7 may thus be used to mix seed and fertilizer or mix different types of particulate material fertilizers in the agricultural industry directly within a single hopper within which the particulate materials are stored. The use of a flow of air under pressure for mixing includes the added benefit of assisting drying of grain in storage hoppers as well.

In a further embodiment of the apparatus 10, a flow restrictor 54 is provided as illustrated in FIG. 8 which is similar to the flow restrictor of the first embodiment. In this embodiment, each of the feed restrictors 68 comprises a venturi tube which becomes narrower in cross sectional area in the direction of flow. A base plate 100 is provided at the bottom of air tube to extend from a bottom opening 102 in the restricting plate member 62 so as to define a further venturi tube between the base plate and bottom wall of the air tube. The venturi tubes all terminate downstream from the auger 32. The orifices 66 in the plate member 62 remain in communication with the suction zone 76 as in the previous embodiment.

Referring now to FIGS. 9 through 12 a further embodiment of the apparatus 10 is illustrated in further detail. In FIG. 9, the apparatus is shown supported at the end of a feed tube 30 which supports an auger 32 therein similarly to the previous embodiment. The feed tube 30 in this instance spans horizontally between a plurality of hoppers 14 of a trailer 16 such that the apex 18 of each hopper is fed through a respective inlet opening in the feed tube 30 so that particular material dispensed therethrough is collected by the auger 32 and urged into the apparatus 10 which is coupled in series with the pneumatic conveying line 12.

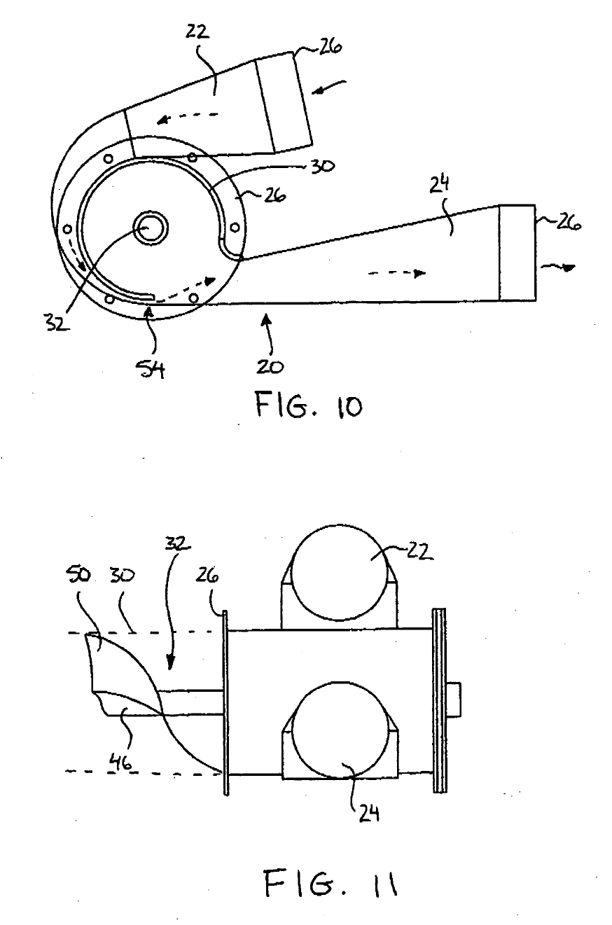

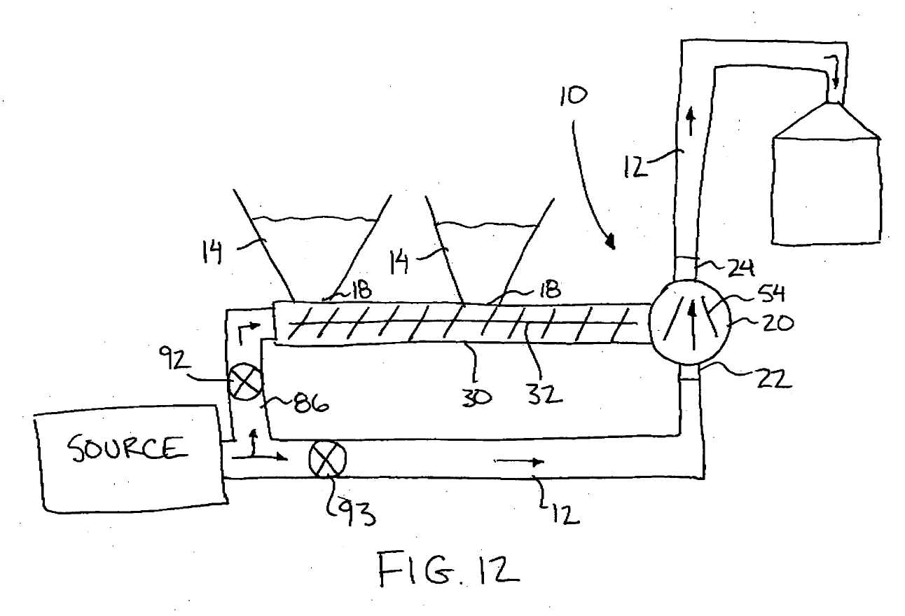

As shown in FIGS. 10 and 11, the feed tube 30 which supports the auger 32 therein, terminates at an air chamber of the apparatus 10 at the end of the feed tube. The air chamber comprises a cylindrical chamber which is coaxial with the longitudinal axis of the auger and the feed tube.

The apparatus includes an air tube 20 forming an air passage therethrough from an air inlet 22 to an air outlet 24. Rim flanges are provided on each of the inlet and outlet portions of the air tube 20 for selective bolted connection in series with the pneumatic conveying line 12. The air inlet and air outlet each include a respective longitudinal axis lying generally tangentially to the feed tube in a common vertical plane perpendicular to the horizontal longitudinal axis of the auger.

A flow restrictor 54 in the form of a venturi defines a portion of the air passage between the air inlet and the air outlet so that the air passage of the air tube 20 is generally U shaped about a periphery of the feed tube. The flow restrictor 54 defining the venturi communicates with the air chamber of the feed tube at a bottom end thereof below the communication of the feed tube with the air chamber.

The air inlet 22 narrows in diameter in the direction of flow downwardly about the periphery of the feed tube to terminate at a narrow throat at the bottom of the feed tube in communication with the air chamber. The air outlet 24 is downstream of the throat and is much greater in diameter to receive the air flow from the inlet at the bottom of the air chamber.

The auger 32 includes a shaft 46 supporting flighting 50 thereon for rotation with the shaft within the feed tube. The flighting is suitably sized to substantially fully span the diameter of the feed tube for effectively urging particulate material from the hoppers into the air chamber of the apparatus. The direction of the auger rotation is arranged such that movement at the periphery of the flighting is in the same direction as flow through the air passage from the inlet to the outlet at the flow restrictor communicating with the air chamber of the feed tube.

As best shown in FIGS. 9 and 12, the source of air under pressure directs a flow of air through the main pneumatic conveying line 12 which includes a branched line 86 connected thereto upstream from the air tube 20. The branched line 86 connects to the input end of the feed tube 30 opposite communication of the feed tube 30 with the flow restrictor 54. A first shutoff valve 92 is connected in series with the branched line 86 to selectively interrupt communication of the conveying line 12 with the inlet end of the feed tube 30. A second shutoff valve 93 is connected in series with the pneumatic conveying line 12 upstream from the air tube 20 and downstream from the branched line 86 to selectively interrupt air flow from the main pneumatic conveying line 12 to the flow restrictor 54.

In this construction, under normal operation in a first operating condition, the first shutoff valve 92 in the branched line is closed while the second shutoff valve in the main pneumatic conveying line in series with the flow restrictor 54 remains open. The full air flow through the line 12 is thus directed through the flow restrictor 54 of the apparatus 10 to pickup particulate material at the outlet of the feed tube 30.

When substantially all of the particulate material has been removed from the hoppers feeding the auger 32 in the feed tube 30, and it is desirable to fully clean out the hoppers and the auger, the valves may be positioned in a second operating condition. In the second operating condition, the first shutoff valve 92 is opened in the branched line in communication with the auger and the second shutoff valve 93 is closed from communication with the main line 12 in series with the flow restrictor 54. Accordingly the full air flow of the main pneumatic conveying line 12 is redirected through the branched line 86 and into the feed tube 30. The air flow is directed through the feed tube in the direction which the auger conveys the particulate material to the air tube 20, and exits through the outlet and of the air tube to subsequently continue along the main pneumatic conveying line 12 to the destination which the particulate material is being conveyed.

With both of the shutoff valves 92 and 93 in the open condition, air is directed to the apparatus through both the inlet of the air tube and through the feed tube 30 which assists cleaning out the auger 32, however when it is desirable to fully cleanout the auger, the second shutoff valve is preferably closed in the second operating condition note above.

In normal operation, air is directed under pressure into the inlet 22 and forced to curve about the feed tube toward the flow restrictor 54 at the bottom end such that a denser flow results at an outer peripheral wall. The flow restrictor 54 produces a drop in pressure by constricting the flow with the denser portion of the air flow remaining at the bottom against the outer wall of the feed tube and the outlet while a lighter flow towards an interior of the air chamber suitably picks up particulate material from the air chamber at the end of the feed tube to be carried away through the outlet 24 into the pneumatic conveying line.

At low capacities, rotation of the auger is slowed down and the venturi produces a suction in the feed tube of the auger to ensure full clean out of the auger. In the illustrated embodiment, one example of a known pressure drop was from an inlet pressure of 7 psi to an outlet pressure of ½ psi.

During normal operation instead of cleanout, the auger is operated at a higher capacity by increasing rotation thereof such that particulate material is packed into the feed tube sufficiently to produce a plug of particulate material providing a seal against air flow in the feed tube. Airflow proceeds from the inlet to the outlet through the flow restrictor at the bottom of the air chamber below the feed tube to pick up the particulate material from the feed tube.

A denser flow results due to the higher concentration of particulate material in the outlet flow to increase downstream pressure producing higher air pressure at the outlet of the flow restrictor. The plug of material in the feed tube due to the accelerated auger prevents back flow of pressurized air into the feed tube. In the same illustrated embodiment, the same air flow resulted in an inlet pressure of 10 psi and outlet pressure of 5 psi at high capacity when the feed tube is packed with particulate material.

As illustrated in FIG. 9, a single horizontal auger 32 can be connected between the apexes of plural hoppers, with each hopper communicating through a respective inlet opening in the feed tube. Connection of the air chamber to the feed tube and of the inlet and outlets 22 and 24 to the pneumatic conveying line are all accomplished with quick couplers or rim flanges bolted to the respective components such that the apparatus can readily be separated or integrally mounted on trailers, rail cars, storage bins, transport trucks and the like. In each instance, the outlet can be disconnected from a first pneumatic conveying line and reconnected to a separate second conveying line where it is desired to direct particulate material to a different collection area. The apparatus 10 may further be provided as a portable unit in which the inlet 22 is connected to an inlet hopper into which particulate material is dispensed from a storage bin and the like.

The resulting apparatus 10 has many advantages in comparison to existing air systems. Traditionally prior art venturi air systems have been used in locations where low volumes need to be moved with minimum equipment and where the air to product ratio is not a concern. Prior art forced feed air systems could be described as a situation where the particulate material is injected into the air stream via mechanical means such as yet not restricted to air lock feeder or auger with flap in these situations there are generally precision moving parts that have to function within the particulate material being conveyed. These systems work excellent in terms of product movement however to clean the system for identity preservation or other customer requirements poses problems as well as being at times labour intensive which tends to make these systems impractical especially if you have only one or two loads between cleanouts. Also these precision parts tend to get damaged and miss function when foreign objects such as metal parts or stones are within the particulate material as can be the case in many instances.

Pressurized vessel air systems can be simply described as adding air pressure to the particulate material in such a manner that the air pressure in the particulate material is in close enough proximity to the air pressure in the air line to be able to introduce the particulate material without additional mechanical assistance.

The apparatus according to the present invention uses some of the principals mentioned in the above relating to venturi air systems, forced feed air systems and pressurized vessel air systems. The apparatus 10 is designed as a venturi and in this particular application uses a screw conveyor to convey and meter the particulate material into the venturi flow. When there is a light flow of material the system operates as a conventional venturi. When the material flow is increased there can be a certain amount of back pressure in the feed system which may hinder the overall capacity of the system, however in this particular application the rotary motion of the screw conveyor coupled with the backwards draft of the escaping air from the venturi opening combine to form a material plug in the conveyor tube that in turn prevents the air from escaping and yet maintain sufficient unload capacity.

The advantage of the apparatus 10 is that it provides some of the simplicity of the vortex system with the capacity of the forced feed system while it can be operated as either a pressurized or non-pressurized system.

In the illustrated embodiment of FIGS. 10 and 11, the only moving parts required within the apparatus is the screw conveyor with its associated hardware, which makes it ideally suitable for identity preserved and other similar handling as it can be readily dismantled and or inspected to meet required industry standards as they apply to the particular product being conveyed.

To further facilitate cleanout after use, an air stream may be introduced into the product feed assembly to help clean out any particulate material left in the conveyance system.

While some embodiments of the present invention have been described in the foregoing, it is to be understood that other embodiments are possible within the scope of the invention. The invention is to be considered limited solely by the scope of the appended claims.

1. An apparatus for dispensing a particulate material from a source of particulate material into a pneumatic conveying line, the apparatus comprising:
an air passage having an air inlet and an air outlet arranged for connection in series with the pneumatic conveying line;
a flow restrictor mounted in the air passage arranged to produce a drop in air pressure in the pneumatic conveying line from an inlet side in communication with the air inlet of the air passage to an outlet side in communication with the air outlet of the air passage;
a feed tube having a feed inlet arranged to be connected to the source of particulate material and a feed outlet connected to the air passage adjacent the outlet side of the flow restrictor; and
a feed mechanism arranged to displace particulate material through the feed tube from the source at the feed inlet of the feed tube to the outlet side of the flow restrictor in the air passage at the feed outlet of the feed tube.

2. The apparatus according to claim 1 wherein the flow restrictor comprises a venturi.

3. The apparatus according to claim 1 wherein there is provided an air chamber at a point of communication of the air passage with the feed tube, the air passage communicating with the air chamber adjacent a bottom side of the air chamber.

4. The apparatus according to claim 4 wherein the feed tube communicates with the air chamber above the air passage.

5. The apparatus according to claim 1 wherein flow directions through the air inlet and the air outlet respectively generally lie in a common plane.

6. The apparatus according to claim 8 wherein the feed tube extends perpendicularly to the common plane of the flow directions.

7. The apparatus according to claim 1 wherein the air passage comprises an air tube which is arranged to be selectively connected in series with the pneumatic conveying line.

8. The apparatus according to claim 1 wherein the air tube includes connection means for releasably connecting the air tube to the pneumatic conveying line.

9. The apparatus according to claim 1 wherein the air inlet and the air outlet each extend tangentially to the feed tube.

10. The apparatus according to claim 13 wherein the feed mechanism comprises an auger rotatable within the feed tube and wherein auger movement at a periphery of the feed tube directly adjacent to the flow restrictor is in a same direction as flow through the flow restrictor.

11. The apparatus according to claim 1 wherein there is provided a branched line having an inlet for connection to the pneumatic conveying line upstream from the air passage and an outlet for connection upstream from the feed tube and a first shutoff valve in series with the branched line for selectively interrupting communication of the pneumatic conveying line with the feed inlet.

12. The apparatus according to claim 11 wherein there is provided a second shutoff valve for connection in series with pneumatic conveying line upstream from the flow restrictor.

13. The apparatus according to claim 12 wherein the apparatus is operable in a first operating condition in which the first shutoff valve is closed and the second shutoff valve is open whereby airflow through the pneumatic conveying line is fully diverted through the flow restrictor.

14. The apparatus according to claim 13 wherein the apparatus is operable in a second operating condition in which the first shutoff valve is open and the second shutoff valve is closed whereby airflow through the pneumatic conveying line is fully diverted through the feed tube.

15. The apparatus according to claim 11 wherein the outlet of the branched line is coupled to the feed inlet.

16. The apparatus according to claim 1 in combination with a particulate material handling trailer having a plurality of hoppers for dispensing the particulate material therefrom wherein the feed tube is arranged to commonly span the plurality of hoppers.

17. The apparatus according to claim 1 in combination with a truck box arranged to store particulate material therein and having a hopper for dispensing the particulate material therefrom wherein the feed tube is arranged to be mounted integrally on the hopper.

18. The apparatus according to claim 1 in combination with a railcar arranged to store particulate material therein and having a hopper for dispensing the particulate material therefrom wherein the feed tube is arranged to be mounted integrally on the hopper.

19. The apparatus according to claim 1 in combination with a particulate material storage bin having a hopper for dispensing the particulate material therefrom wherein the feed tube is arranged to be mounted integrally on the hopper.

20. An apparatus for dispensing a particulate material from a source of particulate material into a pneumatic conveying line, the apparatus comprising:
an air passage having an air inlet and an air outlet arranged for connection in series with the pneumatic conveying line;
a flow restrictor mounted in the air passage arranged to produce a drop in air pressure in the pneumatic conveying line from an inlet side in communication with the air inlet of the air passage to an outlet side in communication with the air outlet of the air passage;
a feed tube having a feed inlet arranged to be connected to the source of particulate material and a feed outlet connected to the air passage adjacent the outlet side of the flow restrictor;
a feed mechanism arranged to displace particulate material through the feed tube from the source at the feed inlet of the feed tube to the outlet side of the flow restrictor in the air passage at the feed outlet of the feed tube; and
a branched line having an inlet for connection to the pneumatic conveying line upstream from the air passage and an outlet for connection upstream from the feed tube and a first shutoff valve in series with the branched line for selectively interrupting communication of the pneumatic conveying line with the feed inlet.
